(19) United States
(12) Patent Application Publication
(10) Pub. No.: US 2003/0022546 A1
(43) Pub. Date: Jan. 30, 2003

(54) CRT aging line load voltage socket

(76) Inventors: Brian Solomich, Escondido, CA (US); David Allen Murtishaw, Sun City, CA (US); Edward Martinez, Vista, CA (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 09/915,651

(22) Filed: Jul. 26, 2001

(51) Int. Cl. H01R 13/627

(52) U.S. Cl. 439/362

(57) ABSTRACT

A load voltage socket is provided for monitoring the load voltage across a CRT during aging so as to determine the current aging condition. The socket is insertable between the CRT and an aging line socket. The socket is provided with a plurality of banana plugs or other connecting means by which the load voltage socket may be conveniently connected to a voltage meter or other measuring instrument for the purposes of monitoring or determining the current aging condition.

### FIELD OF THE INVENTION

The present invention relates generally to methods and apparatuses for monitoring voltages, and more particularly to a method and apparatus for monitoring CRT load voltages during aging processes.

### BACKGROUND OF THE INVENTION

Cathode Ray Tubes (CTRs) are used to render color images in a variety of electronic display systems, including computer monitors, television receivers, oscilloscopes, and medical imaging devices. Each color CRT typically consists of three electron guns (a red, green and blue electron gun) and a phosphor screen that is located inside an evacuated glass envelope. Each electron gun generates a beam of electrons that is accelerated towards the screen by a positive anode voltage.

In CRTs, temperature drifts within the evacuated glass envelope result in image luminance distortion or the alteration of the white balance. The luminance indicates the amount of light intensity which is perceived by the eye as brightness, while the control of luminance is termed “white balance”, since white light may be considered and provided as a mixture of the red, green and blue primary colors in the proper proportions.

To reduce temperature drift, the CRTs are typically subjected to a process known as “aging” during manufacture. This process involves warming up the CRT to facilitate testing of circuitry and adjustment of various display parameters such as color convergence and picture geometry. Conventional aging techniques also typically involve applying an input voltage to each of the three electron guns to cause each electron gun to generate the corresponding luminance.

Since each electron gun generates a different color, each of the electron guns also operates to provide an optimum output at an input voltage which varies from one electron gun to another. Methods and devices are known for compensating for this variation so as to provide suitable input voltages to each cathode in the cathode ray tube, thereby providing optimization of the cathode output for each electron gun during the aging process. Such methods and devices are described, for example, in commonly assigned U.S. Pat. No. 5,977,711 (Van Du et al.).

During the aging process, it is necessary to monitor the load voltage across the CRT in order to determine the current aging condition. Conventionally, this has been accomplished by opening the aging line socket or exposing the wires, and then using a probe (or alligator clip test leads connected to a meter) to take the appropriate reading. This procedure is time consuming in a large scale manufacturing process, and inevitably results in damage to some of the CRTs tested. Moreover, since CRTs operate at high voltages, this approach exposes the technician to the possibility of serious electrical shock.

There is thus a need in the art for a system and method for monitoring the load voltage of the CRT during the aging process which does not require the aging line socket to be opened or the wires to be exposed. There is also a need in the art for a system and method for monitoring the load voltage of the CRT which does not expose the investigator to the possibility of electrical shock. These and other needs are met by the present invention, as hereinafter described.

### SUMMARY OF THE INVENTION

In one aspect, the present invention relates to a load voltage socket suitable for use in determining the aging condition of a CRT, and to the method of using the load voltage socket for that purpose. The load voltage socket is insertable between a cathode ray tube and an aging line socket, and comprises a first end adapted to couple with a cathode ray tube, and a second end adapted to couple with an aging line socket. The first and second ends are in electrical communication with each other such that, when the cathode ray tube is coupled to the load voltage socket and the load voltage socket is coupled to the aging line socket, the cathode ray tube is electrically coupled to the aging line socket.

In another aspect, the present invention relates to an assembly for determining load voltage during the aging of cathode ray tubes. The assembly comprises a cathode ray tube, an aging line socket, and a load voltage socket terminating in first and second ends, wherein the first end of the load voltage socket is adapted to couple with the cathode ray tube, and wherein the second end of the load voltage socket is adapted to couple with the aging line socket.

In still another aspect, the present invention relates to an assembly for determining load voltage during the aging of cathode ray tubes. The assembly comprises a cathode ray tube terminating on one end in a first plurality of pins, an aging line socket terminating on one end in a first plurality of apertures adapted to receive the first plurality of pins, and a load voltage socket terminating in a first surface having a second plurality of apertures disposed therein and terminating in a second surface having a second plurality of pins disposed thereon. The second plurality of apertures is adapted to couple with the first plurality of pins, and the second plurality of pins is adapted to couple with the first plurality of apertures.

In these various aspects of the present invention, the load voltage socket may be provided with communications means for communicating with a voltage meter or other such device such that the aging condition of the CRT may be determined or monitored. Such communications means will typically comprise one or more wires extending from the load voltage socket and equipped with banana clips that can be inserted to one or more ports provided in the monitoring device, though other means of communications, such as wireless communications, may also be employed.

### BRIEF DESCRIPTION OF THE DRAWINGS

FIG. 1 is a side view, partially in section, of a conventional Cathode Ray Tube (CRT) assembly;

FIG. 2 is a perspective view of an aging socket which is shown in conjunction with a portion of a CRT (partially in section) with which the socket is matable;

FIG. 3 is a perspective view of a load voltage socket according to the present invention, which is shown in conjunction with a portion of a CRT (partially in section) with which the socket is matable; and

FIG. 4 is a bottom view of the main socket body of the load voltage socket of FIG. 3 (the circuit housing portion has been deleted for ease of illustration).

### DETAILED DESCRIPTION OF THE INVENTION

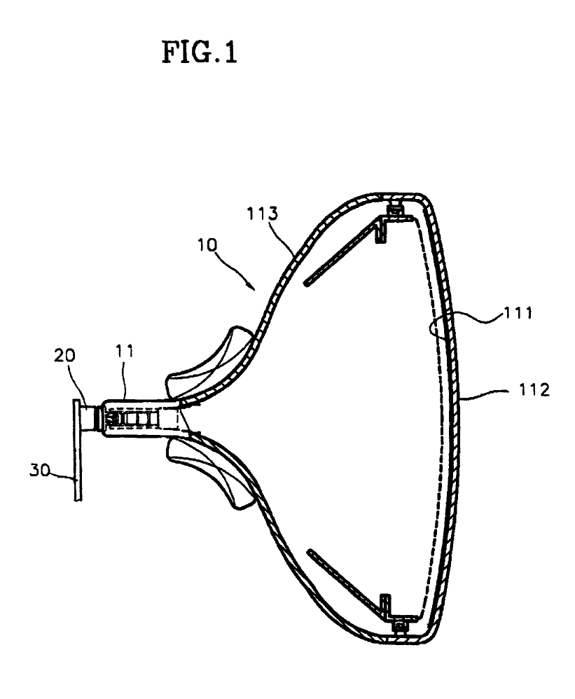

FIG. 1 depicts a CRT aging line assembly. The assembly includes a CRT 10, a socket 20 connected to a neck portion 11 of the CRT for applying voltages to the CRT, and an aging line socket board 30. The CRT includes a panel 112 having a fluorescent layer 111, the inside surface of which is coated with phosphors, and a funnel 113 sealed to the panel.

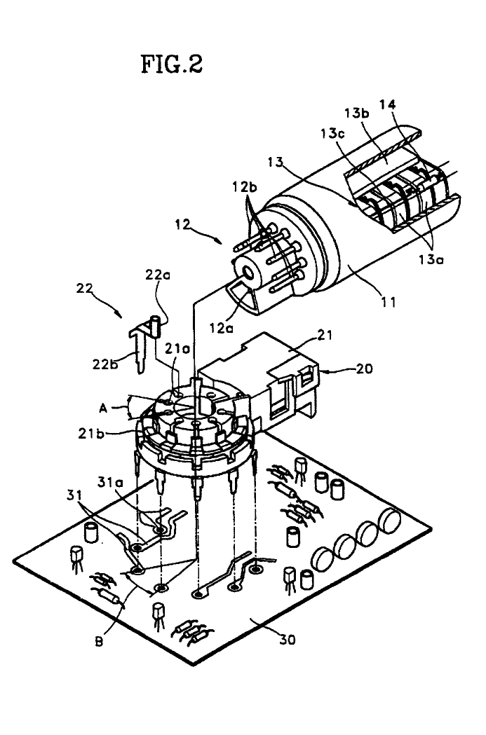

With reference to FIG. 2, an electron gun 13 is installed in the neck portion 11 of the funnel of the CRT. The electron gun includes a multitude of electrodes 13a fixed to a bead glass 13b at intervals. The respective electrodes of the electron gun are electrically connected to the lead pins 12 by connectors 13c. A plurality of holes 21a in a main body 21 of the socket have the same array pattern as the lead pins, and a fixation portion 21b for fixing the connector pins 22 is located at the outer peripheral surface of the main body. In operation, electrical power and input is coupled to the electron gun through the lead pins. The electron gun generates three electron beams that are scanned across the fluorescent layer such that the beams strike phosphors. These phosphors then emit red, green, and blue light so as to generate a color image on the panel.

A connector pin 22 includes a lead pin holder portion 22a and is inserted into a hole 21a of the main body 21 for connection to one of the lead pins 12 of the CRT. The connector pin also includes an outer pin portion 22b extending from the lead pin holder portion and fixed to the fixation portion 21b. Here, the array center of the lead pin holder portion coincides with that of the outer pin portion. Also, the array angle A between the holes with respect to the array center, that is, the array angle of the lead pin holder portion is the same as the array angle B between the signal lines 31, that is, the array angle of the outer portion 22b.

The aging line socket board 30 is equipped with signal lines 31 for applying voltages to the connector pins. These signal lines are formed in a pattern corresponding to the array pattern of the outer pin portion 22b. A connection hole 31a into which the output pin portion is inserted and soldered is formed in the signal line. The signal lines include both high voltage and low voltage lines corresponding to the high-voltage 12a and low-voltage lead pins 12b.

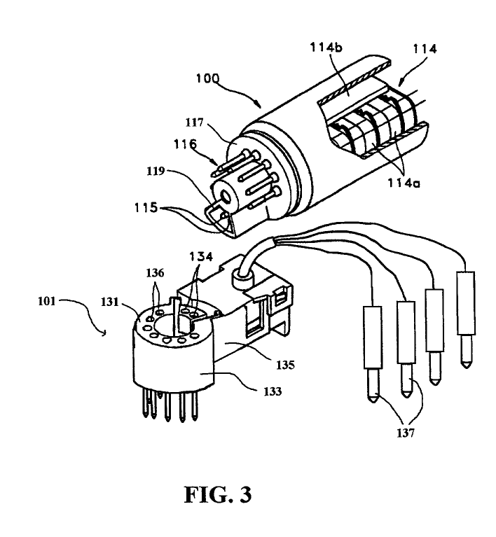

FIG. 3 shows a part of an assembly in accordance with the present invention which includes a CRT 100 and a load voltage socket 101. While various CRTs of various designs may be used in conjunction with the load voltage socket of the present invention, the socket is illustrated with respect to the CRT depicted in FIG. 1 which has an electron gun 114 mounted in a neck portion thereof, it being understood that the configuration of the load voltage plug can be modified as needed to mate with a particular CRT. In the particular configuration depicted, the electron gun comprises a plurality of electrodes 114a which are arranged at intervals on a glass substrate 114b. The respective electrodes are in electrical contact with first lead pins 115 and second lead pins 116.

The first and second lead pins of the CRT are typically disposed in a circular arrangement along the face 117 of the CRT endplate. The first lead pins are adapted to apply a relatively high voltage to electrodes constituting a main lens of the electron gun, while the second lead pins are adapted to apply a lower voltage to the electrodes that constitute the auxiliary lenses of the electron gun and the cathode assembly. There are 7 to 9 second lead pins in a typical CRT assembly, although one skilled in the art will appreciate that the load voltage socket of the present invention can be modified to accommodate a CRT having virtually any number of lead pins.

The first lead pins and second lead pins are, as a group, spaced apart from each other and are separated by a partition 119 which is approximately trapezoidal in shape. The partition is preferably formed of a dielectric material, such as polyvinyl chloride. The partition serves to electrically insulate the two groups of pins from each other, while also serving as a key to ensure that the CRT and the load voltage socket are coupled in the proper orientation.

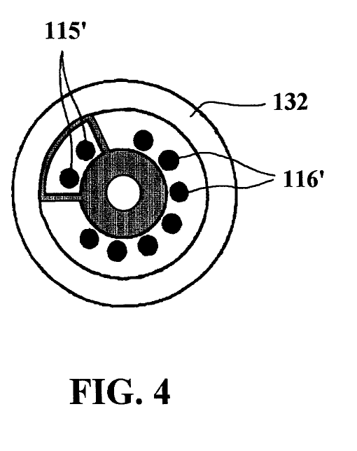

The load voltage socket includes a main socket body 133 and a circuit housing 135. The main socket body is equipped on a first end 131 with a plurality of apertures 134 and 136, which are adapted to accept first 115 and second lead pins 116, respectively, and is equipped on a second end 132 with third and fourth lead pins 115′, 116′ (see FIG. 4). The CRT is matable with the load voltage socket by means of the insertion of the first and second pins into the apertures located on the first end of the load voltage socket. The interiors of the apertures are configured with a suitably conductive material which is in electrical contact with the third and fourth lead pins such that, when the CRT is mated with the load voltage socket, the first and second lead pins are in electrical contact with the third and fourth lead pins, respectively. The third and fourth lead pins are preferably configured in the same manner as the first and second lead pins on the face of the CRT so that the load voltage socket can easily be inserted between a CRT and an aging line socket (see FIG. 1) adapted to accept the pins of the CRT, while at the same time allowing the CRT to be inserted directly into the aging line socket if the load voltage socket is not needed.

The load voltage socket is further equipped with a plurality of banana plugs 137 or other connecting means to allow the load voltage socket to be connected to a voltage meter or other device for the purpose of monitoring the CRT load voltage during the aging process. The number of plugs can vary and will generally be determined by the number of circuits that it is desired to monitor. However, in a typical set-up, one of the plugs will be dedicated to each gun in the CRT, while the other plugs may be devoted to the focusing grid and/or the accelerating grid of the CRT. Other connecting means suitable for this purpose include, but are not limited to, alligator clips and other such means as are known to the art.

Since the load voltage socket can be inserted between the CRT and the aging line socket, it is not necessary to open the aging line socket or expose the wires of the aging line in order to monitor the load voltage across the CRT so as to determine the current aging condition. Rather, the load voltage can be monitored as needed simply by inserting the banana clips into an appropriate voltage meter. This greatly simplifies the monitoring of load voltages during CRT manufacture and, unlike prior art methods for monitoring load voltages, does not expose the technician to electrical shock. Moreover, use of the load voltage socket minimizes handling of the CRT during testing, thereby minimizing the potential for damage to the CRT during the manufacturing process.

Various embodiments and variations of the load voltage socket are possible in accordance with the present invention. For example, while the load voltage socket and the aging line socket will frequently exist as separate components, in some embodiments the load voltage socket and aging line socket may be combined together into a single component which may be mounted to a circuit board by soldering, mechanical coupling, or by other permanent, semi-permanent or reversible means. In such embodiments, this single component will typically be provided with a first end designed to couple with a CRT and a second end designed to couple with the aging line circuit board, and will also be provided with the necessary circuitry and implements to allow it to communicate with a voltage meter or other monitoring device. This device may be external (as in the case of a hand-held unit), or may be built into the aging line device.

The load voltage socket may also communicate with the voltage meter or other monitoring device by various means as are known to the art. Thus, while the device is illustrated above as communicating with the voltage meter by way of a plurality of banana clips, this communication may also occur in a wireless fashion, as, for example, by means of Rf transceivers built into the device.

Moreover, although the load voltage socket is depicted as having a configuration specifically designed to couple with the particular CRT tube and the aging line socket shown, one skilled in the art will appreciate that the load voltage socket may be provided with a universal design capable of coupling with multiple types of CRT tubes and/or aging line sockets. This may be accomplished, for example, by providing the load voltage socket itself with a universal design on one or both ends, or by providing the load voltage socket with one or more adapters enabling it to couple with these devices. With respect to the later, these adapters may be provided or packaged separately, or may be provided with the load voltage socket in the form of a kit.

Various materials may also be used in the construction of the load voltage sockets of the present invention. Typically, the bulk of the plug will be constructed out of a dielectric material such as polyvinyl chloride (PVC) which can be conveniently molded into the desired shape. This material may be provided with dyes, pigments, fillers, strength enhancers, antioxidants, UV adsorbers, and other such materials as are known in the art. The lead pins and circuitry will be constructed out of suitable conductive materials as are known to the art, such as copper, aluminum, gold, or solder (the later of which may further include such materials as tungsten and/or lead). The lead pins and circuitry may also be constructed out of a plated metal (e.g., copper plated with gold).

The plug itself may be provided with appropriate aesthetic accoutrements, such as printed indicia, graphics, or color coding. Thus, for example, the CRT endplate and the load voltage socket may be color coordinated so that the user may rapidly associate a CRT with the proper load voltage socket.

The above description is exemplary, and is not intended to be limiting. Accordingly, the scope of the present invention should be construed solely by reference to the appended claims.

What is claimed is:

1. A load voltage socket insertable between a cathode ray tube and an aging line socket, said load voltage socket comprising:
a first end adapted to couple with a cathode ray tube; and
a second end adapted to couple with an aging line socket;
wherein said first and second ends are in electrical communication such that, when the cathode ray tube is coupled to the load voltage socket and the load voltage socket is coupled to the aging line socket, the cathode ray tube is electrically coupled to the aging line socket.

2. The load voltage socket of claim 1, wherein said first end has a plurality of apertures disposed therein.

3. The load voltage socket of claim 2, wherein said plurality of apertures is adapted to couple with a first plurality of pins disposed on an end of a cathode ray tube.

4. The load voltage socket of claim 1, wherein said second end has a second plurality of pins disposed thereon.

5. The load voltage socket of claim 4, wherein said second plurality of pins is disposed in the same configuration as said first plurality of pins.

6. The load voltage socket of claim 4, wherein each of said first and second plurality of pins has the same diameter.

7. The load voltage socket of claim 3, further comprising at least one wire extending from said voltage socket, said at least one wire being in electrical communication with at least one of said first plurality of pins.

8. The load voltage socket of claim 7, wherein said at least one wire terminates in a banana plug.

9. The load voltage socket of claim 7, in combination with a voltage meter, wherein said at least one wire is in electrical communication with said voltage meter.

10. The load voltage socket of claim 3, further comprising at least one wire extending from said voltage socket, said at least one wire being in electrical communication with at least one of said first plurality of pins.

11. The load voltage socket of claim 1, wherein said load voltage socket has a construction such that, when the cathode ray tube is coupled to the load voltage socket and the load voltage socket is coupled to the aging line socket, the cathode ray tube is electrically coupled to the aging line socket in the proper configuration.

12. The load voltage socket of claim 11 coupled to an aging line socket and a cathode ray tube, said socket being in communication with a monitoring device adapted to assess the aging condition of the cathode ray tube.

13. The load voltage socket of claim 12, wherein the monitoring device comprises a voltage meter.

14. An assembly for determining load voltage during the aging of cathode ray tubes, comprising:
a cathode ray tube;
an aging line socket; and
a load voltage socket terminating in first and second ends, said first end being adapted to couple with said cathode ray tube, and said second end being adapted to couple with said aging line socket.

15. The assembly of claim 14, further comprising a voltage meter in communication with said load voltage socket, said voltage meter and said load voltage socket being adapted for the determination of the load voltage of at least one electron gun in said cathode ray tube.

16. The assembly of claim 14, wherein said voltage meter and said socket are in electrical communication with each other.

17. The assembly of claim 14, wherein said cathode ray tube terminates in a plurality of pins.

18. An assembly for determining load voltage during the aging of cathode ray tubes, comprising:
a cathode ray tube terminating on one end in a first plurality of pins;
an aging line socket terminating on one end in a first plurality of apertures adapted to receive said first plurality of pins;
a load voltage socket terminating in a first surface having a second plurality of apertures disposed therein and terminating in a second surface having a second plurality of pins disposed thereon, wherein said second plurality of apertures is adapted to couple with said first plurality of pins, and wherein said second plurality of pins is adapted to couple with said first plurality of apertures.

19. The assembly of claim 18, further comprising at least one wire extending from said voltage socket, said at least one wire being in electrical communication with at least one of said first plurality of pins.

20. The load voltage socket of claim 19, wherein said at least one wire terminates in a banana plug.

21. The load voltage socket of claim 19, in combination with a voltage meter, wherein said at least one wire is in electrical communication with said voltage meter.
